(19) United States
(12) Patent Application Publication
(10) Pub. No.: US 2009/0216419 A1
(43) Pub. Date: Aug. 27, 2009

(54) Methods and Apparatus for Optical Monitoring of Fluid

(76) Inventor: Andrew Mark Shaw, Exeter (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/719,643

(22) PCT Filed: Nov. 16, 2005
(86) PCT No.: PCT/GB05/50203

§ 371 Date: Mar. 10, 2009

(30) Foreign Application Priority Data
Nov. 19, 2004 (GB) 0425516.2

(51) Int. Cl. F02D 45/00; G01F 23/00; G06F 19/00; G01N 21/41

(52) U.S. Cl. 701/102; 73/290 R; 702/55; 356/128

(57) ABSTRACT

We describe a fuel monitoring system, comprising: an evanescent wave fuel sensor for monitoring said fuel, the sensor comprising a light source and a transducer for providing an electrical signal in response to light from said light source, and having a light path between said light source and said transducer including an evanescent wave sensing region; and a processor coupled to said fuel sensor, for converting said electrical signal from said transducer into a signal characterising said monitored fuel; and an output coupled to said processor, for outputting a signal responsive to said fuel characterising signal. We further describe apparatus for jointly determining depth of fluid in a tank and characterising the fluid according to depth, and a fluid storage tank having a three dimensional structure for containing fluid, and a three-dimensional array of fibre-optic sensors integrated into said tank structure. Embodiments may use cavity ring-down spectroscopy.

This invention is generally concerned with methods and apparatus for optical monitoring of fluid level and/or quality, in particular by means of evanescent wave techniques such as cavity ring-down spectroscopy.

The techniques we describe here are enhanced in their sensitivity, for some applications, by the use of Cavity Ring-Down Spectroscopy (CRDS), and hence it is helpful to outline this technique. However it is important to understand that the use of CRDS, or of multiple passes of a light pulse back and forth within a cavity is not essential.

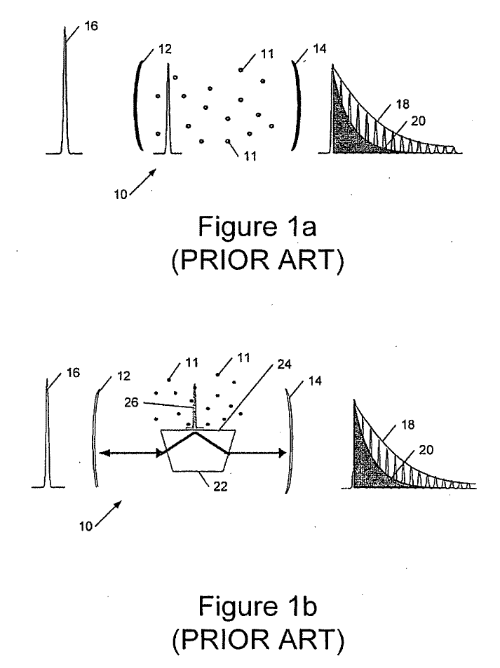

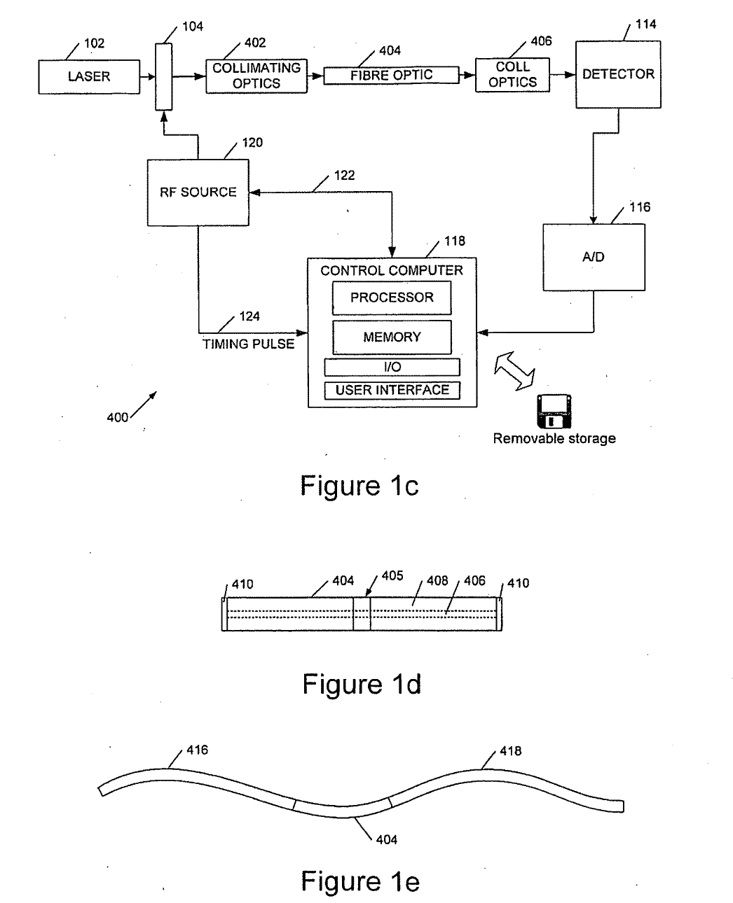

FIG. 1a, which shows a cavity 10 of a gas phase Cavity Ring-Down Spectroscopy (CRDS) device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, t. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δτ, is a function of the strength of absorption of the molecule at the frequency, v_{τ} of interest α (v) (the molecular extinction coefficient) and of the concentration per unit length, lₛ, of the absorbing species and is given by equation 1 below.

Δτ=t_{τ}{2(1−R)+α(v)l_{s}} (1)

where R is the reflectivity of each of mirrors 12, 14 and tᵣ is the round trip time of the cavity, tᵣ=c/2L where c is the speed of light and L is the length of the cavity. Since the molecular absorption coefficient is a property of the target molecule, once Δτ has been measured the concentration of molecules within the cavity can be determined without the need for calibration. Since the decay times are generally relatively short, of the order of tens of nanoseconds, a timing calibration may be needed; this may be performed when the apparatus is initially set up. For CRDS it is desirable to have total losses less than 0.25%, corresponding to around 200 bounces during decay time τ, or approximately 1000 bounces during ring down of the entire cavity—if the total losses in the cavity are say around 1% there will only be 3 or 4 bounces and consequently the sensitivity of the apparatus is reduced. However for embodiments of the apparatus and methods we describe a single or double pass in a cavity is sufficient for some applications.

The basic CRDS technique is only suitable for sensing molecules that are introduced into the cavity in a gas but we have previously described, in WO04/068123 (hereby incorporated by reference in its entirety), evanescent wave CRDS (e-CRDS) can be employed to overcome this problem. Background prior art relating to e-CRDS can be found in U.S. Pat. No. 5,943,136, U.S. Pat. No. 5,835,231 and U.S. Pat. No. 5,986,768.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θ_{c} where sin θ_{c} is equal to n₂/n₁ where n₂ is the refracted index of the medium outside the prism and n₁ is the refractive index of the material of which die prism is composed. Beyond this critical angle light is reflected from die interface with substantially 100% efficiency back into the medium of the prism, but a non-propagating wave, called an evanescent wave (e-wave) is formed beyond the interface at which die TIR occurs. This e-wave penetrates into the medium above the prism but it's intensity decreases exponentially with distance from the surface, typically over a distance of the order of the a wavelength. The depth at which the intensity of the e-wave falls to 1/e (where e= 2.718) of its initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by die e-wave resulting from the total internal reflection at the surface.

FIG. 1c (which is taken from WO04/068123) shows an example of an e-CRDS-based system 100, in which light is injected into the cavity using a continuous wave (CW) laser 102 or some other CW light source, such as a light emitting diode. Preferably this has a power and bandwidth sufficient to overcome losses within the cavity and to couple energy into a plurality of modes of oscillation of the cavity, that is the bandwidth of laser should be greater than one free spectral range of the cavity. The sensitivity of the apparatus scales with the square root of the chopping rate and employing a continuous wave loser with a bandwidth sufficient to overlap multiple cavity modes facilitates a rapid chop rate, potentially at greater than 100 KHz or even greater than 1 MHz.

In the apparatus 100 of FIG. 1c the ring-down cavity comprises mirrors and a total internal reflection device provided by a fibre optic cable 404, the ends of which have been treated to render them reflective to form the cavity. In addition collimating optics 402 are employed to couple light into fibre optic cable 404 and collimating optics 406 are employed to couple light from fibre optic cable 404 into detector 414.

Light is provided to the cavity by laser 102 through the rear of mirror 108 via an acousto-optic (AO) modulator 104 to control the injection of light. In one embodiment the output of laser 102 is coupled into an optical fibre and then focused onto an AO modulator 104 with 100 micron spot, the output from AOM 104 being collected by a further fibre optic before being introduced into the cavity resonator. This facilitates chop times, of the order of 50 ns, which are desirable where the cavity resonator has a relatively low finesse.

A radio frequency source 120 drives AO modulator 104 to allow the CW optical drive to cavity 108, 110 to be abruptly switched off (in effect the AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IEEE bus 122. The RF source 120 also provides a timing pulse output 124 to the control computer to indicate when light from laser 102 is cut off from the cavity 108-110. It will be recognized that the timing edge of the timing pulse should have a rise or fall time comparable with or preferably faster than optical injection shut-off time.

Use of a tunable light source such as a dye laser has advantages for some applications but in other applications a less tunable CW light source, such as a solid state diode laser may be employed, in embodiments operating at approximately 630 nm. It has been found that a diode laser may be switched off in around 10 ns by controlling the electrical supply to the laser, thus providing a simpler and cheaper alternative to a dye laser for many applications. In such an embodiment RF source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo-multiplier tube (PMT) in combination with a suitable driver, optionally followed by a fast amplifier. Suitable devices are the H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; an A to D on board a LeCroy waverunner LT 262 350 MHz digital oscilloscope has been employed. Control computer 118 may comprise a conventional general purpose computer such as a personal computer with an IEEE bus for communication with the scope or A/D 116 may comprise a card within this computer. Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as described below. The code may comprise configuration code for Lab View (Trade Mark), from National Instruments Corp, USA, or code written in a programming language such as C.

FIG. 1d shows details of fibre optic cable 404, which, in a conventional manner comprises a central core 406 surrounded by cladding 408 of lower refractive index than the core. Each end of Hie fibre optic cable 404 is, in the illustrated embodiment polished flat and provided with a multi layer Bragg stack 410 to render it highly reflective at die wavelength(s) of interest. Fibre optic cable 404 includes a sensor portion 405, as described further below.

FIG. 1e illustrates a simple example in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC—type connector.

Preferably optical fibre 404 is a single mode step index fibre, advantageously a single mode polarization preserving fibre to facilitate polarization-dependent measurements. This also facilitates enhancement of the evanescent wave field as p-polarized light (within the plane containing light and the normal to surface) generates an evanescent wave which penetrates further from surface 414 than does s-polarized light.

Where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm; preferably low loss fibre is employed. In one embodiment single mode fibre (F601A from INO) with a core diameter of 5.6 μm (a cut-off at 540 nm, numerical aperture of 0.11, and outside diameter of 125 μm) and a loss of 7 dB/km was employed at 633 nm, giving a decay time of approximately 1.5 μs with a one meter cavity and an end reflectivity of R-0.999. In general the decay time is given by equation 2 below where the symbols have their previous meanings, f is the loss in the fibre (units of m⁻¹ i.e. percentage loss per metre) and/is the length of the fibre in metres.

Δτ=1ᵣ/{2(1−R)+f1} (2)

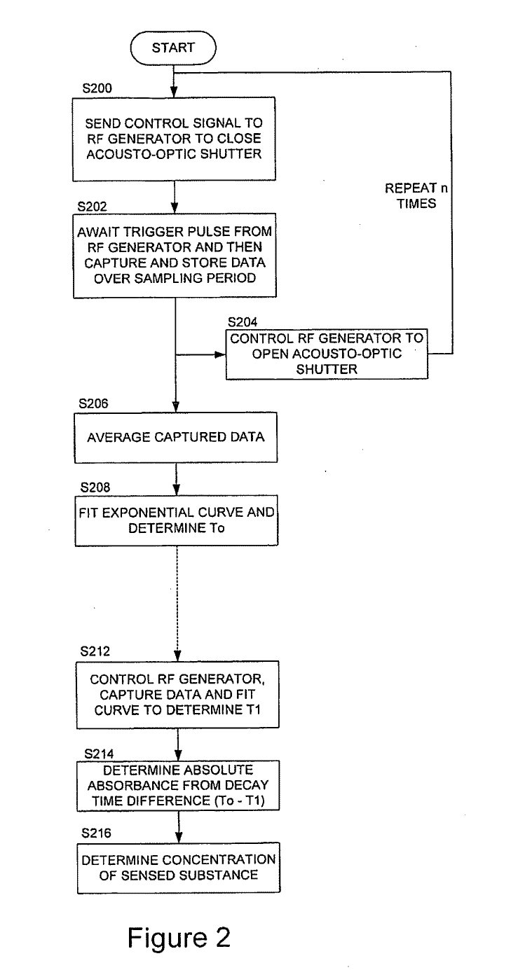

FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1G samples per second (1 sample/ns at either 8 or 16 bit resolution) preferably over a period of at least five decay lifetimes, for example, over a period of approximately 5 μs Computer 118 then controls RF generator to re-open the shutter and the procedure loops back to step S200 to repeat the measurement, thereby capturing a set of cavity ring-down decay curves in memory. With this example period it should be possible to repeat measurements at a rate of up to approximately 20 kHz. The data from the captured decay curves are averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e= 2.718). Any conventional curve fitting method may be employed; one straight—forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

This initial decay time measurement may be part of a calibration procedure.

Following this the procedure then, at step S212, effectively repeats steps S200-S208 when the sampled material is present, capturing and averaging data for a plurality of ring-down curves and using this averaged data to determine a sample cavity ring-down decay time τ₁. Then, at step S214, the procedure determines an absolute absorption value for the sample using the difference in decay times (τ₀-τ₁) and, at step S216, the presence of the sensed substance or species can be detected and optionally the substance characterized.

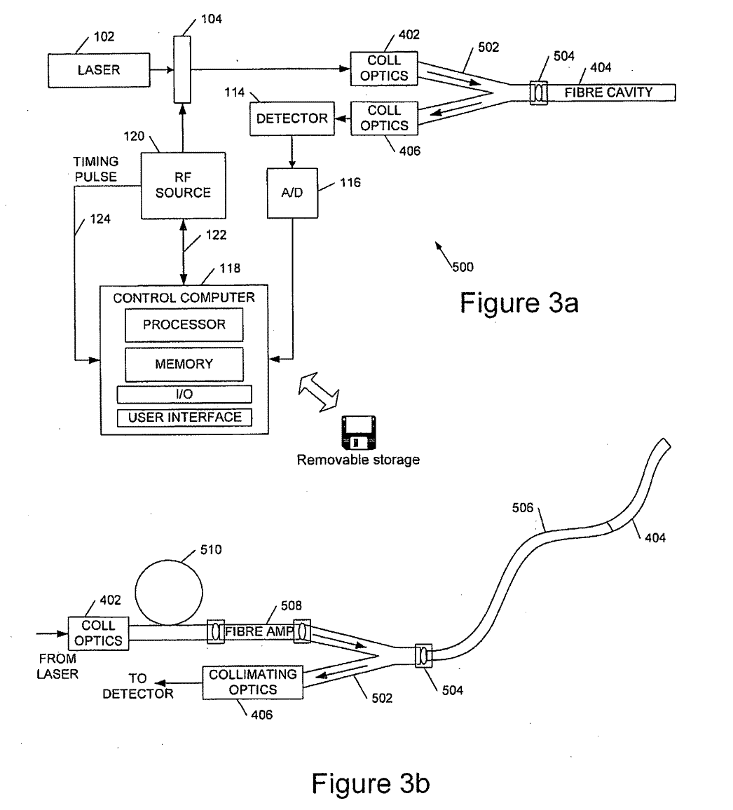

FIG. 3a this shows a variant of the apparatus of FIG. 1c, in which like elements are indicated by like reference numerals. Here a single-ended connection is made to fibre cavity 404 although, as before, both ends of fibre 404 are provided with highly reflecting surfaces. A conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow laser light to be launched into fibre cavity 404 and light escaping from fibre cavity 404 to be detected from a single end of the cavity. This facilitates single-ended use of the fibre cavity-based sensor.

FIG. 3b shows a variant in which fibre cavity 404 is coupled to Y-connector 502 via an intermediate length of fibre optic cable 506 (which again may be coupled to cable 504 via a FC/PC connector). This also illustrates the use of an optional optical fibre amplifier 508 such as an erbium-doped fibre amplifier. In the illustrated example fibre amplifier 508 is acting as a relay amplifier to boost the output of collimating optics 402 after a long run through a fibre optic cable loop 510 (for clarity the pump laser for the fibre amplifier is not shown). Many other configurations are possible—for example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimetres from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

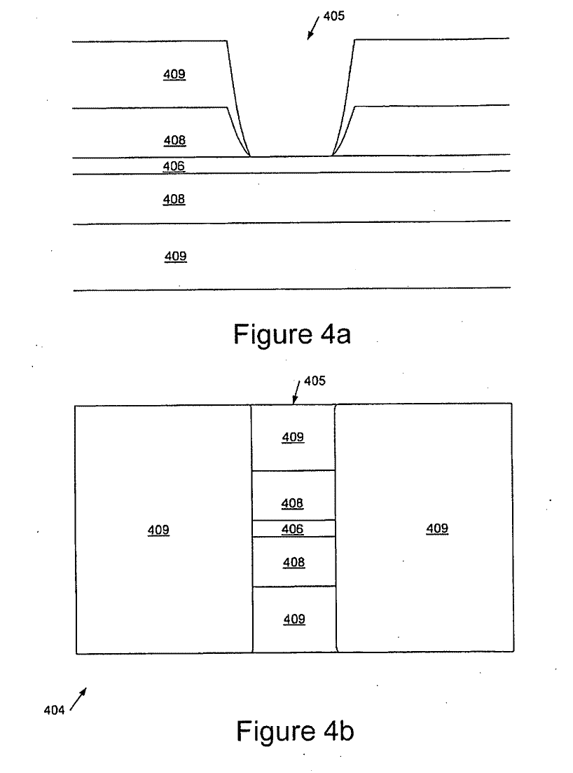

To utilize the fibre optic cavity 404 as a sensor of an e-CRDS or other evanescent wave based instrument access to an evanescent wave guided within the fibre is needed. FIGS. 4a and 4b show one way in which such access may be provided; others are described later. Broadly speaking a portion of cladding is removed from a short length of the fibre to expose the core or more particularly to allow access to the evanescent wave of light guided in the core by, for example, a substance to be sensed.

FIG. 4a shows a longitudinal cross section through a sensor portion 405 of the fibre optic cable 404 and FIG. 4b shows a view from above of a part of the length of fibre optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure mat losses are kept well under one percent. It will be recognized that, if desired, multiple sensor portions may be provided on a single cable.

A sensor portion 405 on a fibre optic cable may be created either by mechanical removal of the casing 409 and portion of the cladding 408 or by chemical etching. For example in a mechanical removal process the fibre optic cable is passed over a rotating grinding wheel (with a relatively fine grain) which, over a period of some minutes, mechanically removes the casing 409 and cladding 408. The point at which the core 406 is optically exposed may be monitored using a laser injecting light into the cable which is guided to a detector where the received intensity is monitored. Refractive index matching fluid is provided at the contact point, this having a higher refractive index than the core so that when the core is exposed light is coupled out of the cable and the detected intensity falls to zero.

It has been recognised that evanescent wave-based techniques including, but not limited to e-CRDS can be employed to problems relating to the optical monitoring of fluid level and quality.

According to a first aspect of the present invention there is therefore provided a fluid storage tank having a three dimensional structure for containing fluid, and a three-dimensional array of fibre-optic sensors; and wherein said array of sensors is integrated into said tank structure.

Preferably there is also provided a sensing system to determine a level of the fluid within a tank at a plurality of different orientations of a tank (with respect to gravity).

Thus in a related aspect the invention provides a fluid level sensing system for determining a level of fluid in a container, the system comprising: a sensor input to receive sensor data from at least two sets of fluid level sensors, a first set of sensors disposed at intervals along a first direction within said container and a second set of sensors disposed at intervals along a second direction within said container, said second direction being different to said first direction; and a signal processing system to process said sensor data and able to determine a level of fluid in said container for a plurality of different orientations of said container.

The invention also provides a fluid sensing system for determining a level of fluid in a container, the system comprising: a sensor input to receive sensor data from a set of fluid sensors disposed at intervals along a first direction within said container; and a signal processing system configured to process said sensor data to determine both a level of fluid in said container and a condition of said fluid at one or more of said sensors within said fluid.

Preferably the fluid level sensors comprise evanescent wave fluid level sensors, such as e-CRDS sensors, and preferably therefore the system further comprises interface apparatus for interfacing to such sensors to provide the sensor data for subsequent processing. Preferably the first and second directions are substantially orthogonal; in some preferred embodiments three sets of sensors, preferably disposed along substantially mutually orthogonal directions, are provided. This enables determination of die fluid level substantially irrespective of an orientation of the container (albeit with a granularity dependent upon the sensor spacing).

In some preferred embodiments an attenuated total internal reflection (ATIR) measuring system for interfacing to a sensor to optically determine die condition of the fluid comprises a light source to interact with the fluid, a detector for detecting a level of light from the light source, and an optical path between the light source and the detector, the optical path including a reflection from a substantially totally internally reflecting interface. The apparatus, or more particularly the fibre optic sensing region, is configured such that the fluid may be brought sufficiently close to the TIR interface or an evanescent wave formed by (attenuated) total internal reflection of light at the interface to interact with the fluid. This allows a condition of the fluid to be determined from the detected light level.

Preferably the optical path includes a minor or other reflecting surface so that the light makes a double pass through a sample region comprises the TIR interface. This facilitates fabrication of a single ended device and increases sensitivity. In some embodiments the fibre optic may be provided with a protective housing.

The interaction of the evanescent wave with the fluid will generally include some absorption of light by the fluid, but other interactions may also be present. For example dependent upon the refractive index of the fluid (which may change with temperature age, use/history, contamination, and the like) there may be some coupling or propagation of light from the TIR interface into the fluid. Thus the sensing system may be drought of as sensing die complex refractive index of the fluid, that is both a real component of the refractive index and an imaginary component representing absorption. The skilled person will understand that although reference is made to TIR-based sensing when fluid is present in the sensing region of a fibre optic sensor die TIR will be attenuated and may even disappear, depending upon how effectively light is coupled out of die fibre into the fluid or absorbed by the fluid.

In some embodiments two or more sensing wavelengths or colours may be employed (either a discrete or continuous spectrum). Measuring at two, three, four or more colours facilitates determining a level or concentration of particulates within the fluid (which may be used as a measure of degradation of the fluid) since scattering is wavelength dependent (as inverse 4^{th} power of wavelength) whereas a change in response to, say, a change in temperature of the monitored fluid will tend to affect all die different wavelengths/colours in a similar manner. Alternatively the fluid may comprise two (or more) different components which may be mixed in regions and separated in other regions; the different responses of die sensors may be used to identify these regions and, for example, an approximate ratio of one fluid to the other present to determine, for example, a degree of contamination or a quantity of contaminate present.

Embodiments of the signal processing system may be implemented by means of computer program code, which may be provided on a carrier such as read-only memory (firmware), or on a disk, or on a signal carrier such as an optical or electrical signal carrier. Such computer program code may be written in any conventional computer program language and may optionally be distributed between a plurality of coupled components, for example over a network.

To facilitate coupling of a continuous wave laser to the fibre optic sensor to provide advantages as described in the applicant's previous application WO 04/068123, the fibre optic cable (cavity) may have a length of at least 0.1 m, 0.5 m, 1.0 m or more (although shorter cavities may also be employed).

In a related method the invention provides a method of jointly determining depth of fluid in a tank and characterising the fluid according to depth, the method comprising: providing a plurality of fibre optic sensors at a plurality of different depths within said fluid, each said fibre optic sensor comprising a region where an evanescent wave of light propagating within the fibre optic is able to interact with said fluid; monitoring light propagating within the fibre optic associated with each said sensor region to determine a plurality of complex refractive index values of said fluid, one in the vicinity of each sensor region where said fluid is present; and determining the depth of fluid in said tank and characterising said fluid according to depth using said plurality of complex refractive index values.

The plurality of fibre optic sensors may be provided on separate sensing fibres or a number of sensors may be multiplexed, for example wavelength division multiplexed, onto a single fibre. The sensors may be arranged in one, two or three dimensions; a single wavelength or colour or a plurality of different wavelengths/colours may be employed.

The invention further provides apparatus for jointly determining depth of fluid in a tank and characterising the fluid according to depth, the apparatus comprising: a plurality of fibre optic sensors configured for positioning at a plurality of different depths within said fluid, each said fibre optic sensor comprising a region where an evanescent wave of light propagating within the fibre optic is able to interact with said fluid; a monitor system to monitor light propagating within the fibre optic associated with each said sensor region to determine a plurality of complex refractive index values of said fluid, one in the vicinity of each sensor region where said fluid is present; and a data processing system coupled to said monitoring system to determine the depth of fluid in said tank and to characterise said fluid according to depth using said plurality of complex refractive index values.

In a further aspect the invention provides a fuel monitoring system, the system comprising: an evanescent wave fuel sensor for monitoring said fuel, the sensor comprising a light source and ac transducer for providing an electrical signal in response to light from said light source, and having a light path between said light source and said transducer including an evanescent wave sensing region; and a processor coupled to said fuel sensor, for converting said electrical signal from said transducer into a signal characterising said monitored fuel; and an output coupled to said processor, for outputting a signal responsive to said fuel characterising signal.

Preferably the light path comprises a light guide, in particular a fibre optic, for example configured as a dipstick. In preferred embodiments the electrical signal from the evanescent wave sensor is responsive to the refractive index of the fuel and the fuel characterising signal is determined in response to the fuel refractive index-dependent electrical signal, for example using a look-up table. However, it will be appreciated that, in embodiments, there is no need to explicitly determine the fuel refractive index to characterise the fuel.

The fuel characterising signal may comprise, for example, a signal determining a water concentration in the fuel and/or, in other embodiments, residual traces of dye and/or die presence of other contaminants such as toluene.

In the UK “red diesel” is chemically marked and dyed red to show that it is taxed at a reduced rate. Similar techniques are used in other countries. The dye makes the fuel easy to detect but there are techniques for its removal. Similarly fuel may be diluted, for example with toluene (paint shipper), dry cleaning fluids, water or the like.

In a further aspect, therefore, the invention provides a system for detecting fuel excise duty fraud, using the above described fuel monitoring system for detecting a fuel contaminant.

In some preferred embodiments, the fuel monitoring system includes means for compensating for variations in fuel temperature. This may comprise a temperature sensor such as a thermistor providing an electrical output to the processor to allow the processor to determine and compensate for the temperature of the fuel. More particularly the refractive index of a typical liquid (oil-derived) fuel decreases by approximately 4×10⁻⁴ with every degree rise in temperature. Thus if the temperature (or change in temperature) is known, the refractive index can be corrected responsive to the temperature before determining the fuel characterising signal. Preferably the temperature compensation system is able to correct for temperature changes of less than 0.5° C. or preferably less than 0.1° C.

In other embodiments the temperature compensation system employs optical temperature compensation. More particularly the light source may be configured to provide two (or more) different wavelengths of light (for example, using two separate emitters), one wavelength where the monitored fuel has an absorption feature, and a second wavelength where there is substantially no absorption feature. Conceptually one wavelength is used to monitor the fuel, whilst the second remains substantially unaffected by the fuel condition so that a ratio of (loss) measurements at these two wavelengths can be used to determine a temperature compensated signal. In embodiments the loss through a fibre optic taper used to provide access to the evanescent wave is substantially constant so that a ratio of signals at these two different wavelengths may be used to determine a temperature compensated refractive index for the fuel.

In a further aspect the invention provides a system for protecting an engine from use of an inappropriate fuel comprising a fuel monitoring system as described above coupled to a fuel supply restriction system. The fuel characterising signal may comprise a simple binary signal to distinguish between two different fuel types, for example diesel and petrol, and then, for example, the fuel supply to a petrol engine can be cut off when the fuel monitoring system detects diesel in the fuel supply.

In a still further aspect the invention provides an engine management system comprising a fuel monitoring system as described above.

Thus in a further aspect the invention provides an engine management system for an engine comprising: an evanescent wave optical fuel sensor for monitoring a condition of a fuel supply to said engine; and a controller coupled to said fuel sensor and having an output to control operation of said engine responsive to said monitored condition of said fuel supply.

In embodiments the controller may comprise part of an existing engine management system which receives a signal from the evanescent wave optical fuel sensor. Interpretation of data from the optical fuel sensor may be performed, for example, as part of a software process within an existing system to determine data characterising the fuel supply to the engine responsive to an electrical (or optical) signal from the sensor.

Further aspects of the invention provide methods corresponding to the above described systems.

The invention further provides carrier medium carrying processor control code to implement the monitoring and/or determining and/or characterising features of the above described methods and systems; the invention further provides code to implement the data processing and other systems described above.

This and other aspects of the invention will now be further described, by way of example only, with reference to the accompanying figures in which:

FIGS. 1a to 1e show, respectively, the principle of CRDS system, the principle of an e-CRDS system, a fibre optic based e-CRDS system, a fibre optic for the system of FIG. 1c, and a second fibre optic for the system of FIG. 1c;

FIG. 2 shows a flow diagram illustrating operation of the system of FIG. 1c;

FIGS. 3a and 3b, show respectively, a second fibre optic based e-CRDS device, and a portion of a variant of this device;

FIGS. 4a and 4b show, respectively, a cross section view and a view from above of a sensor portion of a fibre optic cavity;

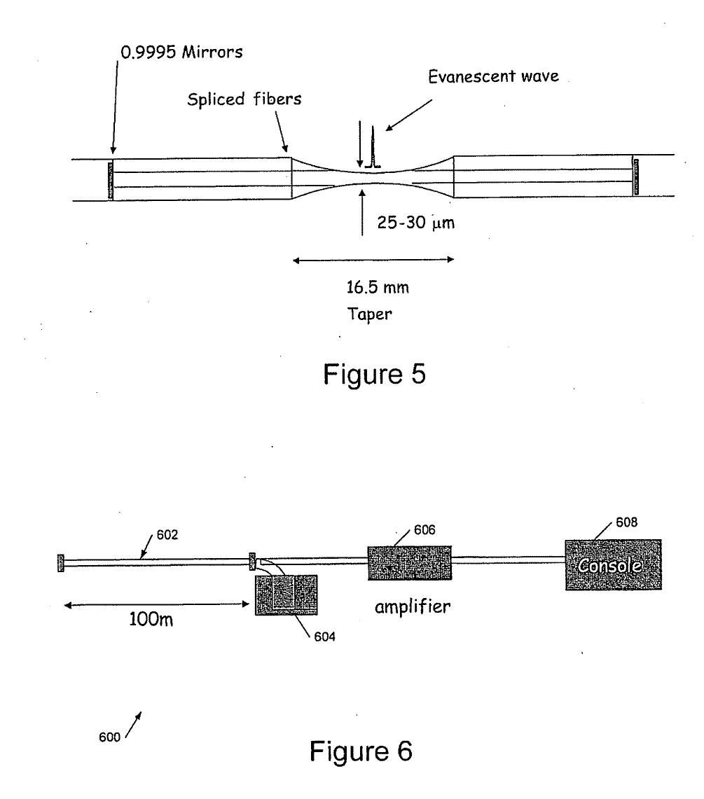

FIG. 5 shows a fibre optic cavity incorporating a taper;

FIG. 6 shows a wavelength division multiplexed fibre optic cavity sensor system;

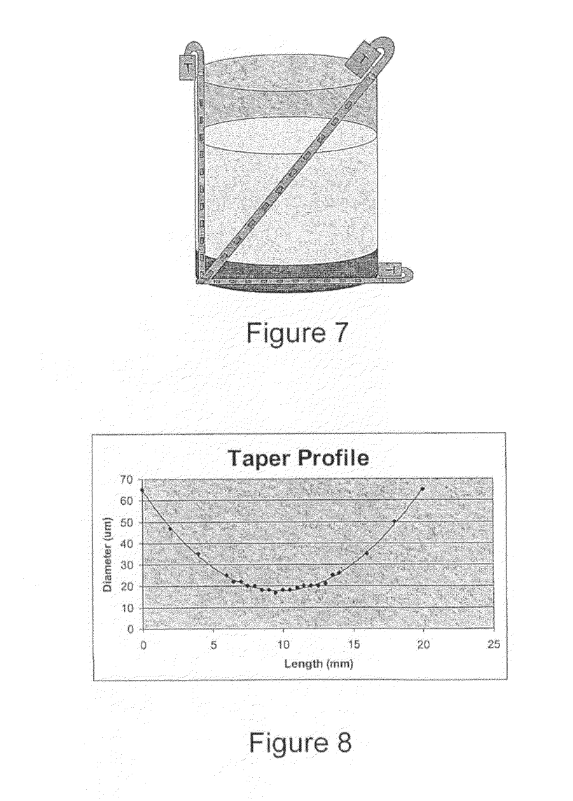

FIG. 7 shows an overview of an optical level and quality monitoring system;

FIG. 8 shows a taper profile of a fibre optic sensor;

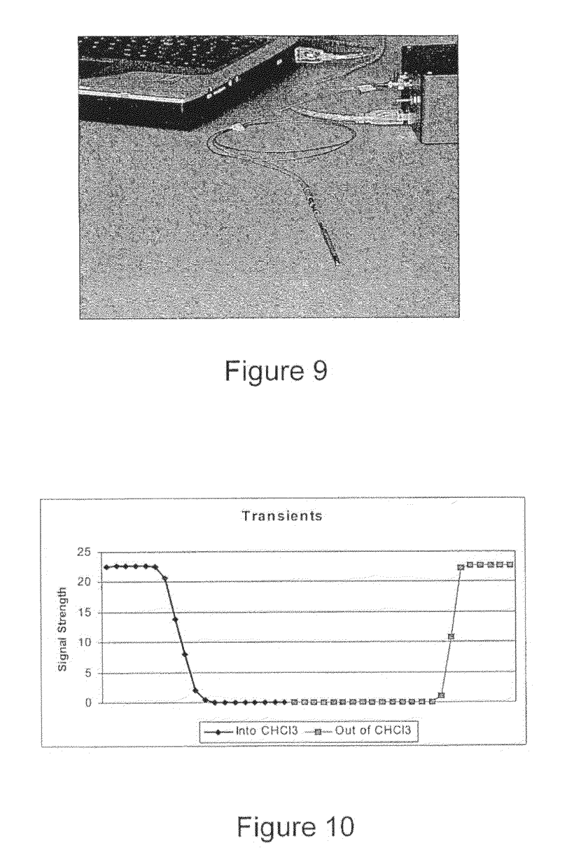

FIG. 9 shows an illustration of a “desktop” detection system in a “fibre optic dipstick” configuration;

FIG. 10 shows optical signal strength for incremental dip transients;

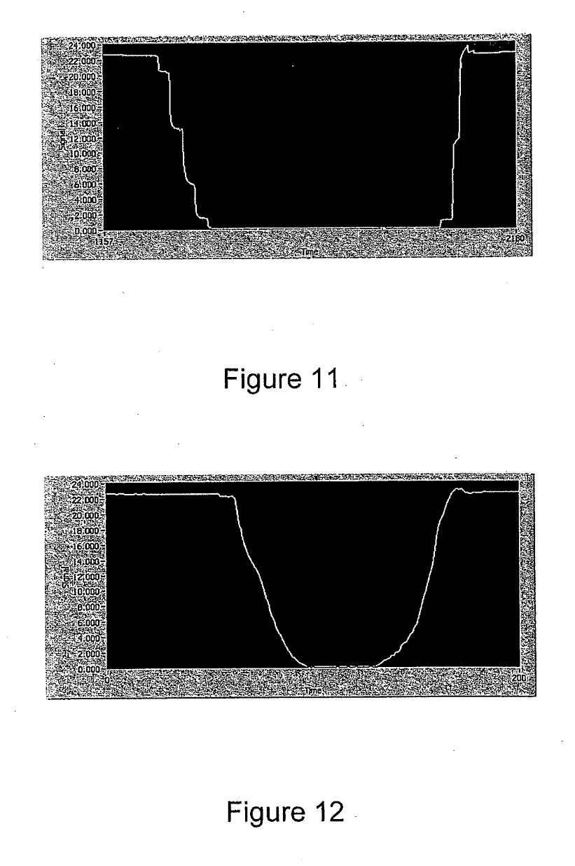

FIG. 11 shows an example of a real time output of a fibre optic dipstick incremental dip trial;

FIG. 12 shows an example of a real time output of a fibre optic dipstick continuous dip transient trial;

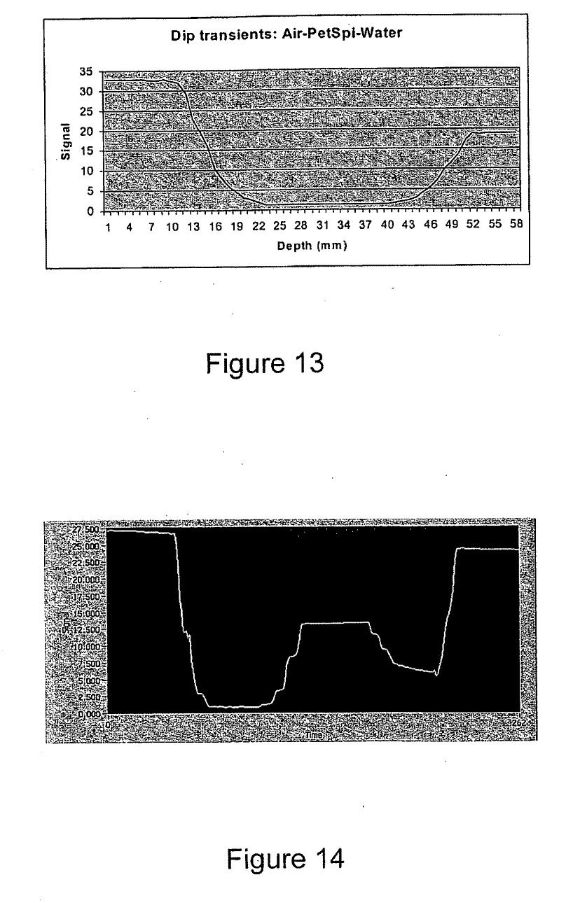

FIG. 13 shows optical signal against depth in millimetres for incremental dip through a three layer air-petroleum spirit-water system;

FIG. 14 shows signal strength against time illustrating real time dipstick transients through the three layer system of FIG. 13;

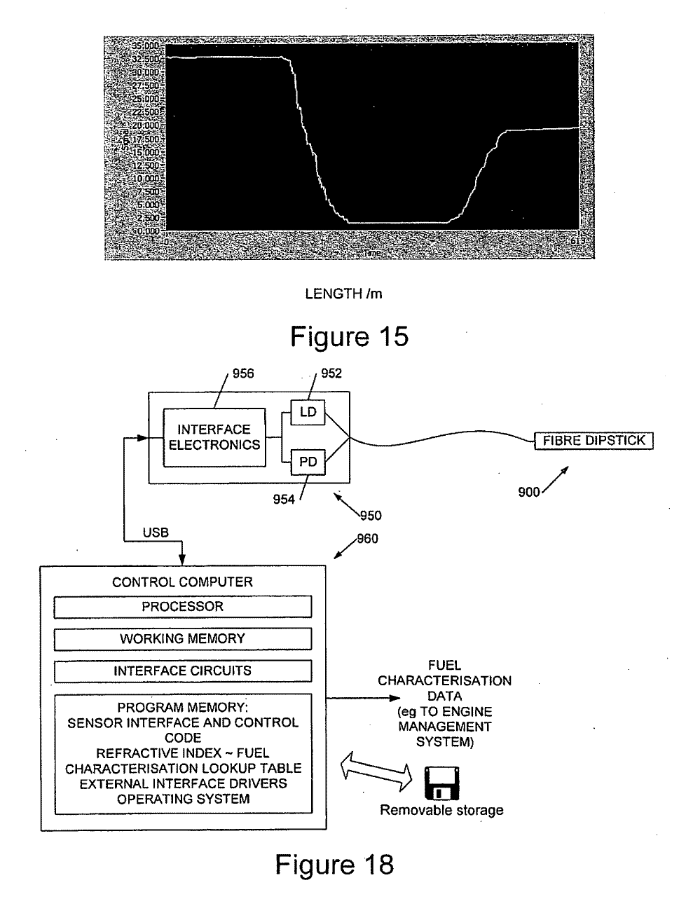

FIG. 15 shows signal strength against time showing continuous real time transients through a three layer air-petroleum spirit-water system;

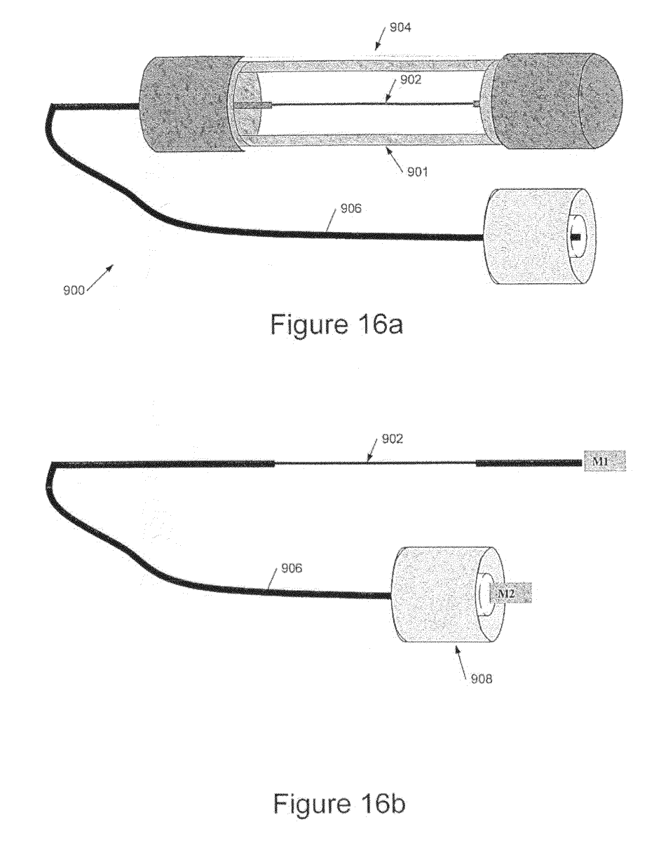

FIGS. 16a and 16b show, respectively, a further example of a fibre optic dipstick, and a fibre optic cavity for the dipstick of FIG. 16a;

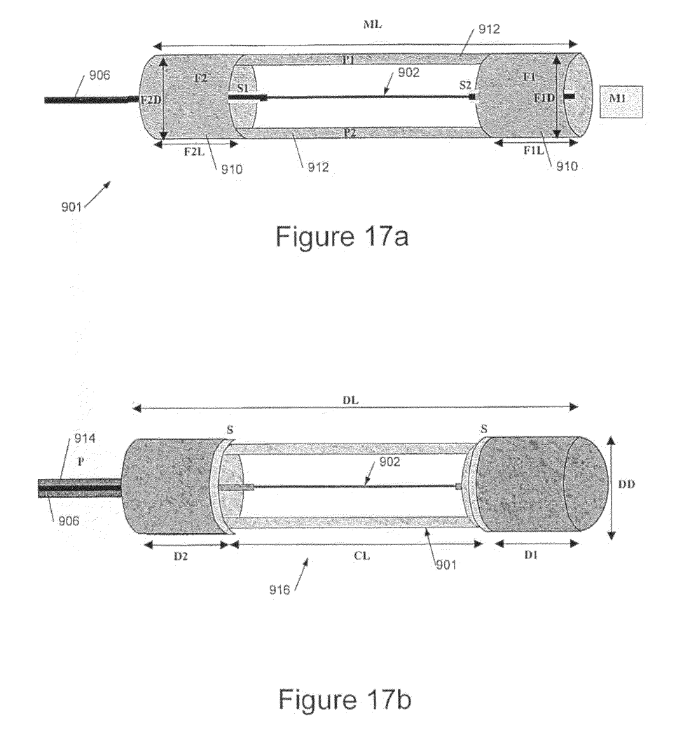

FIGS. 17a and 17b show, respectively, a fibre optic sensor module, and a dipstick incorporating the module;

FIG. 18 shows an embodiment of a fuel monitoring system according to an embodiment of an aspect of the invention;

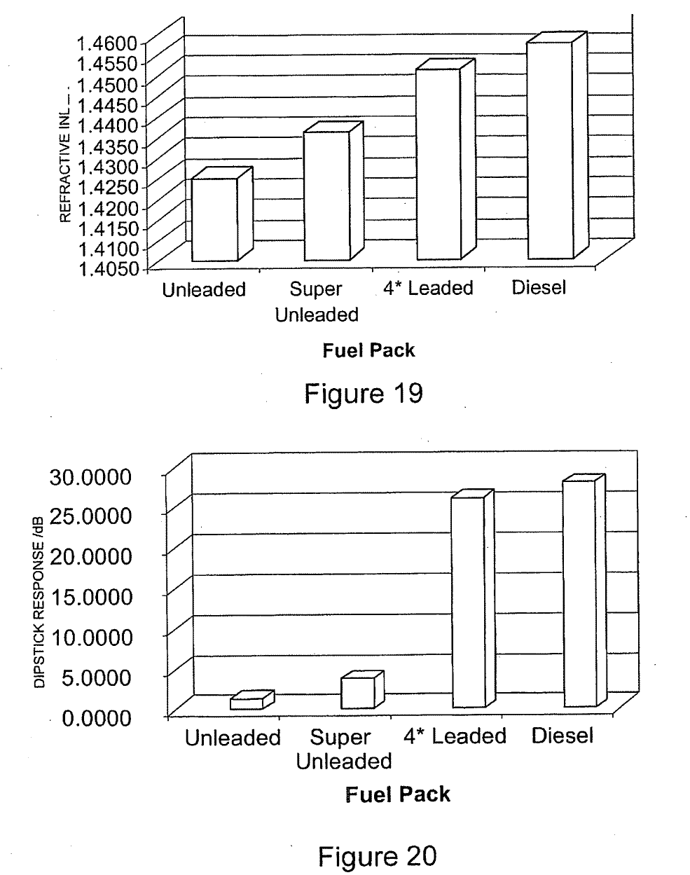

FIG. 19 shows refractive index measurements of commercial fuel packs;

FIG. 20 shows response in dB loss for commercial fuel packs measured using a tapered fibre optic sensor according to an embodiment of the invention;

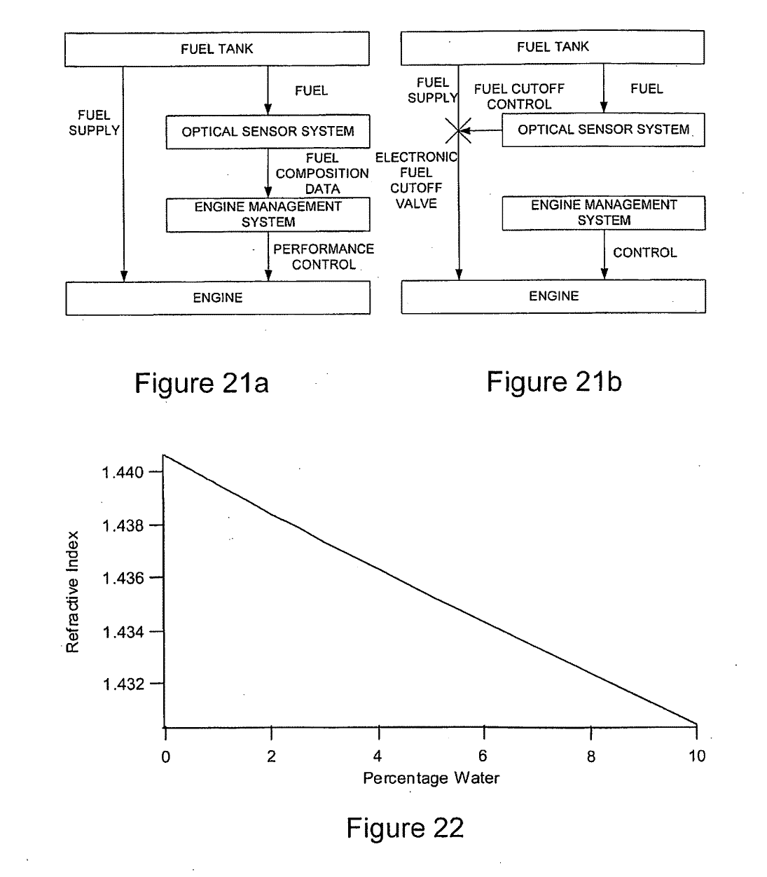

FIGS. 21a and 21b show, respectively, a fuel management system according to an embodiment of an aspect of the invention, and a fuel supply cut-off system according to an embodiment of an aspect of the invention; and

FIG. 22 shows variation of fuel pack composition with water concentration.

We first describe fabrication details of some example fibre optic cavities.

Fibre optic was purchased from Oz Optics (Ontario, Canada) with a minimum absorption at 633 nm specified at 7 dB km⁻¹. The losses at 633 nm are dominated by the absorption losses of the silica in the fibre and a shift to longer wavelength can allow the operation of the cavity in a region of lower losses in the absorption spectrum of the silica. The minimum absorption occurs at 1.5 μm, the telecom wavelength. The specification for the fibre is shown in Table 1 below.

TABLE 1
Fibre specification INO 601A

| | |
|---|---|
| Losses/dB km⁻¹ | 7 |
| Numerical Aperture | 0.11 |
| Core Diameter/μm | 5.6 |
| Cladding Diameter/μm | 125 |
| Optimised Wavelength/nm | 635 |
| Cut off Wavelength/nm | 540 |

The fibres were fabricated in two batches, one supplied and prepared with high-reflectivity minor coatings by INO (Institute National d'Optique—National Optics Institute, Quebec, Canada), and one supplied by Oz optics with high-reflectivity mirror coatings provided by Research Electro Optics (REO), Inc, of Colorado, USA. Each fibre was polished flat as part of a standard INO preparation procedure and then connectorised with a standard FC/PC patchchord connector. For the REO batch the mirror coatings were applied to the end of the polished fibre with the FC/PC connectors in place. The fabrication process may coat the mirrors before or after connectorisation. The batch from INO was supplied as patch-chords with a rugged plastic covering around the fibres (likely added after the mirrors were coated); the batch sent to REO had no outer coating, except the silicone covering, around 1 mm in diameter to minimise out-gassing during the coating processes.

Two minor reflectivity custom coating runs were performed, by Oz Optics and by REO. Oz specified a coating reflectivity of better than 0.9995; REO specified 0.9999 or better reflectivities by their standard processes. These mirror coatings reflectivities are manufacturer's estimates.

Fibre optic tapers were prepared under contract by Sifam Fibre Optics, Torquay, Devon, UK, tapering the fibre optic revealing some of the evanescent wave, as described above, allowing it to couple to molecules in the outside medium. This was measured with a solution of crystal violet (CV⁺), which has an absorbance at 633 nm-CV⁺ placed on the surface of the taper absorbs the radiation from the evanescent field and this is seen as a loss in the intensity of the radiation in die fibre.

The fibre of Table 1 has a “W” index profile which leads to increased losses in the tapering process, and therefore tapers were drawn in the fibre specified in Table 2 below, which has a simple step index profile. A tapered fibre was then spliced into a cavity to provide an overall cavity length of 4.2 m; more than one taper could be spliced into a cavity in a similar way. The cavity length was chosen to be this length to increase the ring down time τ (which has a linear dependence on tᵣ the round nip time). To reduce the splicing losses the mirrors may be deposited onto a fibre with a desired index profile.

TABLE 2

| Fibre Lot ID | CD01875XA2 |
|---|---|
| Cladding Diameter/μm | 124.72/125.51 |
| Coating Diameter/μm | 248.77/248.9 |
| Attenuation at 630 nm/dB km⁻¹ | 7.09 |
| Cutoff/nm | 612.4/619.5 |
| Mean Fibre Diameter at 630 nm/μm | 4.28/4.62 |

Observed ring down times, τ, for a selection of un-tapered fibre cavities (fabricated and coated by Oz Optics) are given in Table 3 below. Ring-down was captured using a digital oscilloscope and averaged 256 times at a repetition rate of 8 KHz and then input to a signal processor (personal computer) which fitted a single exponential using a standard (non-linear) Levenberg-Marquardt procedure.

TABLE 3

| Cavity | Cavity Length/m | τ ± σ/μs | Comments |
|---|---|---|---|
| FC1 | 2 | 1.23 ± 0.023 | Oz Optics Fibre and |
| | | | Mirrors στ/τ = 0.96% |
| FC2 | 2 | 2.176 ± 0.033 | Oz Optics Fibre and |
| | | | Mirrors στ/τ = 1.29% |
| FC3 | 1 | 0.823 ± 0.013 | Oz Optics Fibre and |
| | | | Mirrors στ/τ = 1.58% |
| FC4 | 1 | 1.050 ± 0.015 | Oz Optics Fibre and |
| | | | Mirrors στ/τ = 1.43% |
| FC5 | 1 | 0.538 ± 0.065 | Oz Optics Fibre and |
| | | | Mirrors στ/τ = 1.20% |
| FC6 | 1 | 0.402 ± 0.025 | Oz Optics Fibre and |
| | | | Mirrors στ/τ = 0.61% |
| FC7 | 2 | 1.870 ± 0.023 | Oz Optics Fibre and |
| | | | Mirrors στ/τ = 1.22% |
| FC8 | 2 | 0.801 ± 0.028 | Oz Optics Fibre and |
| | | | Mirrors στ/τ = 3.54% |

We turn next to the fabrication of tapered cavities. The telecoms industry has developed a technology for fusing fibre optics together, coupling two or more input fibres into one output fibre. This achieved by tapering the fibres and fusing the cores of the incoming fibres to the output fibre. In tapering a single fibre optic some of the evanescent field is revealed from the core and samples the region outside the taper—this is the basis of the tapered fibre cavity.

Tapered fibre cavities may be made by pulling under heating to a known radius to produce the taper, for example by Sifam, as mentioned above. The taper may then be spliced into a fibre cavity to form a complete sensor, as shown in FIG. 5. The observed losses for a taper prepared with INO fibre are large due to the “W” shaped refractive index profile of these fibres and instead a step index profile fibre is preferable; this may then be spliced into an INO fibre cavity. The tapered region may be supported in a ‘U’ shaped gutter. In an alternative fabrication technique mirrors are deposited onto a fibre that is appropriate for tapering; losses of the taper may then be monitored by CRDS during the taper preparation. For CRDS losses are tolerable for tapers of diameter 25-30 μm.

The measured ring-down times and losses for each of four tapered fibre optic cavities are shown in Table 4−EV1 and EV2 are cavities prepared from INO fibre with REO mirrors specified at R=0.9999; EV3 and EV5 comprise INO fibre and mirrors specified at R= 0.9995−EV3 and EV5 have signal intensities from a photomultiplier (PMT, 50Ω termination) of the order 40 mV whereas EV1 and EV2 have a signal intensity of order 7 mV.

TABLE 4

| | Taper | Estimated | Observed | Observed |
|---|---|---|---|---|
| Fibre Cavity | Length/mm | Loss/dB | τ/ns | Loss/dB |
| EV1 | 16.15 | — | 114 ± 1.7 | 0.86 |
| EV2 | 16.42 | 0.01 | 129 ± 7 | 0.75 |
| EV3 | 16.70 | 0.02 | 300 ± 3 | 0.31 |
| EV5 | 16.78 | 0.01 | 337 ± 15 | 0.27 |

We next consider fibre cavity losses.

The losses in fibre optic are measured in decibels (dB) per kilometre, with the dB defined by die following equation:

$$dB = 10 {log}_{10} ( \frac{{P}_{in}}{{P}_{out}} ) \qquad ( 3 )$$

where Pᵢₙ and Pₒᵤₜ are the input and output powers respectively. The losses in CRDS experiments are measured by the ring-down time, x, with contributions from:

Iₙ=(R(v)T_{f}Lᵢ exp(−α(v)l))²ⁿI₀ (4)

Where R(v) is the frequency dependent reflectivity of the mirrors, T_{f} is the transmission loss of the fibre and Lᵢ are all other losses to include scatter and diffraction effects. The absorption of any molecular species within the cavity is assumed to follow Beers Law with l being the length of the cavity and n is the number of bounces. Absorption within the evanescent field will also be by Beers law but with an effective penetration depth for the radiation, d_{c}, and a concentration profile. Equation 4 can be re-arranged to give:

Iₙ=exp(−2n(α(v)l−ln R−ln T_{f}−ln Lᵢ))I₀ (5)

Transforming to the time variable t= 2nl/c, where c is the speed of light and l is the length of the cavity, the expression now shows the expected form for the exponential decay of radiation intensity within the cavity:

$$I ( t ) = exp ( - \frac{ct}{l} ( α ( v ) l - ln R - ln {T}_{f} - ln {L}_{i} ) ) {I}_{0} \qquad ( 6 )$$

The ring down time of the cavity, t, is given by:

$$τ = \frac{{t}_{r}}{2 ( α l - ln ( R ) - ln ( {T}_{f} ) - ln ( {L}_{i} ) )} \qquad ( 7 )$$

where tᵣ is the round trip time of the cavity. Using the Taylor series approximation −ln(R)≈(1−R) at R=1, the conventional equation for die losses of an empty free-space cavity with losses dominated by the minor reflectivities can be recovered:

$$τ = \frac{{t}_{r}}{2 ( 1 - R )} \qquad ( 8 )$$

where tᵣ is the round-trip time and R is the mirror reflectivity.

The Taylor series expansion is a good approximation for R=0.9999 with −ln(R)−(1−R)=5×10⁻⁹, Five parts in a billion. With R= 0.999, the difference is 5×10⁻⁷, or five parts in 10 million and for R= 0.99, the difference is 5×10⁻⁵, five parts in 100 000. So for all calculations with fibre cavities this is a good approximation.

Considering now non-tapered fibre cavity losses, the losses in the fibre cavities without the tapers have an exponential decay with a ring down time given by:

$$τ = \frac{{t}_{r}}{2 ( ( 1 - R ) + ( 1 - {T}_{f} ) + ( - {L}_{i} ) )} \qquad ( 9 )$$

With a cavity of 2 m in length and a specified fibre loss of 7 dB km⁻¹, R= 0.9995 and Lᵢ=0, the predicted ring down time of the cavity is (all calculations of losses are per round-trip with a silica refractive index of 1.4601):

$$τ = \frac{\frac{2 \times 2}{c} \times 1.4601}{2 ( ( 5 \times {10}^{- 4} ) + ( 1 - {10}^{- \frac{7 \times 4 m}{{10}^{4}}} ) )} \\ τ = \frac{1.9533 \times {10}^{- 8}}{2 ( ( 5 \times {10}^{- 4} ) + 6.426 \times {10}^{- 3} )} \\ τ = 1.410 μ s \qquad ( 10 )$$

This compares with the measured cavity τ=1.23±0.025 μs (for FC1). Hence the fibre transmission losses dominate the losses in the cavity and determine the ring down time. There are still some additional losses that are not accounted for by the 7 dB⁻¹ cm⁻¹ loss for the fibre and the effective fibre losses are 8.6 dB km⁻¹ (cf FC2 where τ=2.176 is consistent with effective fibre losses of 4 dB/km). This may be because fabrication of the high reflectivity mirrors on the end of the fibre may not be as easy as expected and the observed mirror reflectivities may be lower than the specified 0.9995. Dropping the mirror reflectivities to 0.999 gives a limiting value of t=1.315 μs. The discrepancy in the mirror reflectivity and the estimate of the fibre loss are all very close to the observed limiting loss and can easily be explained in terms of fabrication losses (under specification mirrors, uncertainty in the loss parameter)—it should therefore be possible to improve upon these. It is noted that the batch of cavities performs, without optimisation, to within 12% of the specified limit.

Considering now tapered cavity losses, the observed ring down time for spiced cavities 4.2 m long was 300±0.02 ns, which corresponds to a round-trip loss of 7.72×10⁻² or 7.7% (0.3 dB). Hence the fibre transmission, including the two splices and the taper is 0.9274.

Measurements with a high index liquid (1.51) show a drop in the ring down time of the cavity consistent with the presence of an evanescent field within the taper. The losses from the taper and the splices are clearly significant, more than was estimated from the matching of the external diameters of the fibres, 0.04 dB. This figure produces an estimated loss, per round trip including a total of four passages through die splices, 3.6%, indicating the splicing and taper losses are larger than predicted.

Experiments suggest that long fibre cavities may be deployed without significant loss of sensitivity and opens die potential for fibre optic cavity networks.

A fibre optic cavity may be fabricated with a broadband mirror. The ring down time and hence die sensitivity of fibre based e-CRDS is determined by the propagation losses in the fibre and die production of the taper. The losses in the fabrication of a single taper have yet to be determined but appears that the mirrors are not the limiting factor. This enables the reflectivity specification to be lowered to values around 0.999. Mirror production techniques allow the preparation of broadband very high reflectivity coatings over a wavelength region of at least 500-1000 nm. This enables radiation of different wavelengths to propagate along the same cavity, for example to interrogate different sensor regions.

Wavelength division multiplexing (WDM) in fibre optics is a well established technique in die telecoms industry and wdm coupler and switch technology can be employed to couple multiple wavelengths into a common cavity for parallel detection scenarios. For example switching of radiation of different colours, say red, green and blue, can be straightforwardly incorporated into a fibre network design, as shown schematically in the fibre sensor network 600 of FIG. 6. Referring to FIG. 6, a fibre cavity 602 includes one or more tapered regions to provide one or more evanescent wave sensing surfaces and hence a network of sensors. Light at a plurality of wavelengths, for example red, green and blue light from laser diodes or other sources, is coupled into the cavity by wdm light source 604 and cavity ring-down is monitored by amplifier 606, for example comprising a fibre amplifier, and console 608. Console 608 may comprise, for example, a wavelength division demultiplexer coupled to one or more PMTs (each) having a digitised output, these signals being provided to a computer programmed to determine cavity ring-down time at each of the wavelengths and hence to determine a (change in) cavity loss at the relevant wavelength (as described above) to provide a combined sensed signal/data output or plurality of sensed signal/data outputs. Console 608 may also provide centralised monitoring/command/control of the sensor network.

We now consider die operation of free-running cavities. As previously mentioned a free-running cavity structure allows a broad bandwidth cw laser to overlap with many cavity modes so that radiation will always enter the cavity. The observed ring down profile is then a convolution of the ring down of several modes each in principle with the own, slightly different τ. Each τ will depend on how flat the mirror reflectivity curve is over the bandwidth of the laser and whether there are any frequency dependent losses (e.g. diffraction losses) that are significantly different over the bandwidth of the laser. The free-running cavity allows die laser to be chopped at, for example, 10 kHz, which may be averaged to improve the noise statistics. With a stable cavity, the ring-down time shows a deviation error, Δτ/τ<1%, which determines the ultimate absorbance sensitivity of the fibre cavity technique.

The absorbance by a species in the cavity is related to the cavity length (the round-trip time) and the minimum detectable change in τ, the ring down time given by the formula:

$$Abs = \frac{Δ τ}{τ} \frac{{t}_{r}}{2 {τ}_{0}} \qquad ( 11 )$$

The molecular concentration can then be determined using equation 12:

Absorbance=εC L (12)

where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 12 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Work to date suggest that estimates of Δτ/τ are not generally better than 1% and the detection sensitivity is thus given by the round-trip time and t of the empty cavity, τ₀. The minimum detectable absorbance for die fibre cavity, 1 m long, is 4.3×10⁻⁵; this provides a two-fold improvement in sensitivity compared with a bench top Dove cavity with a minimum detectable absorbance limit of 7.4×10⁻⁵. The calculation for the fibre cavity assumes the observed ring-down time of 1.23 μs but this may be improved upon by optimising the fabrication.

We now consider cavity modes: The longitudinal modes of a cavity are dependent on the length of the cavity with the separation between the modes known as the free special range (FSR). For a 2 m fibre cavity the FSR (n=1.4601):

$$\begin{matrix}δ v = \frac{n c}{2 l} \\ δ v = \frac{1.4601 \times 2.99 \times {10}^{8}}{4} \\ = 109 MHz\end{matrix} \qquad ( 13 )$$

For a cavity 100 m long the separation FSR becomes 2.1 kHz. The power intensity within a free-running cavity depends on the overlap of the input radiation with the cavity modes. The free-running cavity overlaps at least two modes, one FSR, and so light will always couple into the cavity. The output profile of a laser is generally rather broad, of order 5 nm, and so generally only a fraction this will couple to the cavity.

Coupling light into the cavity depends both on the number of longitudinal modes overlapped by the input light source and the width of the modes. The full width half max (FWHM) of each mode is controlled by the cavity finesse as defined below.

Considering now cavity finesse and Q-factor, the width of the modes is controlled by the finesse of the fibre cavity is given by:

$$F = \frac{π \sqrt{R}}{( 1 - R )} \qquad ( 14 )$$

For a 0.9995 cavity dominated by the mirror losses, the finesse of the cavity is 3140. If R is replaced by die general round trip loss for the fibre cavity, (0.9921) then die finesse of the fibre cavity is 396.

The Q-factor may be defined by equation 17 below, which for the fibre cavity takes the value 395.7—in close agreement with the calculated cavity finesse.

$$Q = \frac{2 πτ}{{t}_{r}} \qquad ( 15 )$$

From die relation Finesse=FSR/FWHM, the calculated FWHM for the modes in the fibre cavity is 275 kHz, and thus in a long cavity modes overlap to effectively provide a “white light” cavity into which light over a continuous range of wavelengths can be coupled.

In the configurations discussed above multimode fibres may be used as an alternative to single mode fibre, and a range of different index profiles may be employed to give a range of taper configurations. In some preparation processes tapers may be prepared in situ with a mirrored fibre so the losses can be monitored as die taper is pulled; this may be used to optimise die ring down time with the taper present in the cavity. Also, as mentioned, different taper thickness may be drawn to control die amount of evanescent field present outside the fibre and hence interaction with sensor molecules. Controlling the taper thickness can also be used to adjust die dynamic range of the sensor. Changing (increasing) the length of the taper changes (increases) the interaction length for the sensor surface and this can increase the sensitivity of a sensor. The networking potential for the sensors has been established, with cavity lengths of up to 100 m or more.

It appears that in some circumstances there is an advantage in moving to longer wavelengths to those used for the experiments described above. For example, increasing the detection wavelength from 639 nm to 820 nm or longer has the potential to reduce propagation losses within a fibre. Light sources are available at high power both at 820 nm and 1.5 μm, products of the telecommunications industry and the fibre transmission losses are generally much lower at 820 nm, ˜2 dB km⁻¹ giving ring down time for a 2 m cavity of 4.1 μs and a round trip transmission of 0.997. Thus loss is still dominated by the fibres at 820 nm and the mirror losses do not need to be better than 0.999. At 1.5 μm the fibre losses are 0.18 dBkm⁻¹ and for a 2 m cavity give a cavity ring down time t of 14.7 us with a round hip transmission of 0.9993. Mirror reflectivity now becomes important and a cavity operating at this wavelength would preferably employ a 0.9995 or better mirror specification. At each wavelength the cavity parameters changes and the power and detection characteristics can be balanced by routine experiment. Calculation of the minimum detectable absorbance change using equation 11 suggests that the detection limit at 820 nm will be nearly 4 times better than at 639 nm and at 1.5 μm, some 10 times better than at 639 nm. Hence an 820 nm cavity will have a detection sensitivity of order 2×10⁻⁵. The skilled person will recognise that fibre optic e-CRDS will work within any fibre optic of tolerable transmission loss (of order 8 dB km⁻¹).

In general, in such a sensor system an output from a ring-down detector such as a PMT responsive to a light level within the cavity is digitised and provided to a signal processor such as a general purpose computer system, programmed in accordance with the above equations to determine a cavity ring-down time and hence a cavity loss. This information may be output directly (either as an output signal from the computer or as data written to a file or provided by a network connection) or further processing may be applied to determine a sensor signal

We now describe techniques for monitoring fluids, and apparatus for jointly sensing/monitoring a fluid level and the fluid's complex refractive index.

We will describe the monitoring of level and quality of a tank of fluid. This is performed optically by an array of sensors in one, two or three-dimensions to monitor the depth of the liquid by monitoring the complex refractive index at each array element. The elements are individually fibre linked to a telemetry control containing a three colour light source. The complex refractive index is a measure of the chemical composition of the fluid at the level of each array element. FIG. 7 shows optical level monitor and quality control in 3D; T is telemetry.

The sensors may be fabricated as an array in 3D integrated into the structure of the storage tank; 3D sensing enables the fluid level to be determined at the accuracy of the array spacing throughout the tank irrespective of die orientation of the tank. Array software provides orientation of the tank with respect to gravity in 3D.

Temporal array interrogation provides information on:
a. Acceleration of the fluid in the tank and hence the tank
b. Rotation of the tank
c. Rate of consumption of the fluid in the tank

A single array may be fabricated as a dipstick for single dip tests for tank depth interrogation.

The system provides determination of the complex refractive index of the fluid at each array element. For example:
a. Determination of overall chemical composition of the fluid; and/or
b. Multi-colour (red, NIR and IR) complex refraction index determination, which can be matched to the RI of the fibre optic and die specification of the array element

Preferably each array element is tapered fibre optic with a controlled fabrication specification targeted to the composition of the fluid within the tank. Preferably the losses in the fibre taper are controlled by the complex refractive index of the medium within the evanescent file (e.g. ˜200 nm from the surface).

In embodiments monitoring the complex refractive index at 10 ppm sensitivity levels or better with multi-wavelengths enables;
a. Chemical composition to be determined; and/or
b. Scatter losses to be determined to monitor particle size; and/or
c. Transition from one fluid to another to be determined to monitor separation of fluids based on miscibility and density e.g. for fuel and water.

In embodiments control of the taper profile and minimum diameter enables the coupling of radiation through the evanescent field to tuned to a specific task:
a. Very optically dense materials, such as crude oil, can be analysed; and/or
b. The colours of die material may be monitored for Tax duty control, e.g. measuring the concentration of dye molecule added to duty-free fuels monitoring the biofilm on surface of the tape can be used to monitor long-term degradation of die signal.

For example, the preparation of a tapered fibre allows the evanescent wave to explore a region of the medium above the fibre substantially equal to the penetration depth. The penetration depth is of order λ where λ is the wavelength of the radiation and hence for the wavelengths mentioned above the penetration depth will be of order 600-1000 nm. This facilitates monitoring levels of optically dense fluids such as oil where direct absorbance measurements are difficult or impossible.

We next describe a “proof of principle” procedure. Two immiscible liquids, water (distilled) and chloroform (CHCl₃), are allowed to settle in two layers based on their density in a test tube. Radiation at 637 nm is launched into a single-mode taper with a minimum diameter of 17 μm and a length (over which the taper is 150 percent of its minimum diameter) of 7.5 mm, FIG. 8.

The taper has been fabricated into a dipstick with a protective housing allowing the tapered region to be exposed to the fluid. One end of the fibre has been deposited in silver to provide a reflectivity of approximately 80 percent and the other end of the fibre has been FC/PC connectorized for easy coupling into the detection box. Radiation from the laser is launched into the taper and returned via a 50:50 coupler to the detector. The signal is digitised at a rate of 10 Hz and passed to the control PC for analysis. The entire detection system is powered by the PC USB, FIG. 9.

The dipstick is then lowered into the immiscible liquid system either continuously or incrementally with vertical steps of 0.5 mm. The incremental vertical dip results are shown in FIG. 10 with the real-time dip transient profile shown in FIG. 11. The vertical axis shows a photo-detector response with the maximal reading corresponding to approximately 5 μW of 637 nm radiation returned from the dipstick.

The response of the detector is limited by the digitisation rate of the interface. In water the dipstick shows little or no loss with the radiation guided successfully by the tapered fibre optic. As the tapered region enters the high refractive index fluid light is coupled out of the laser throughout the length of the taper at a level that is consistent with the exposure of the evanescent field and the degree of coupling to the medium. All of the radiation is ultimately coupled out of the taper when immersed in the CHCl₃ providing a binary yes-no result for immersion into the liquid. When the dipstick is withdrawn from the fluid the radiation intensity within the dipstick recovers to its initial value at a rate controlled by the evaporation of the CHCl₃ from the surface of the taper.

The same experiment was performed with a continuous dip and the transient is shown in real time in FIG. 12. Again all of the radiation is removed from the fibre taper when completely immersed in the high-refractive index fluid, with the intensity returning to the original value on removal of the taper.

We next describe separation monitoring. A similar series of experiments was performed with the taper in the dipstick configuration recording the transients of the taper when passing from air to petroleum spirit and then to a settled water layer. The petroleum spirit has a refractive index greater than the fibre (1.457) and couples the radiation out of the dipstick completely. However, transition into water layer, with the lower refractive index results in some of the radiation intensity being removed due to the complex refractive index of the surface, FIG. 13. The real time response of the dipstick is shown in FIG. 14 with the continuous dip transients shown in FIG. 15.

A more complete analysis of the transients may be made using a knowledge of the detailed microlayer structure of the surface of the taper as it passes through the two fluids. Micron-sized droplets of oil forming on the hydrophilic surface of the taper induce scatter of radiation from the cavity contributing to the complex refractive index of the fluid. Additional factors contribute to the complex refractive index of the fluid including absorbance at a wavelength of the radiation and scatter. The dipstick is a sensitive monitor of the complex refractive index of the material and hence composition.

We have thus demonstrated the potential of the tapered fibre dipstick to monitor the composition of a fluid and the transition between fluids of different refractive index. Tuning the coupling of the evanescent filed to the fluid by controlling the length and the diameter of the taper, the response of the dipstick can be controlled to give either an on-off binary response to being within the fluid or to measured response that is characteristic of the complex refractive index of the medium. Hence it is possible to monitor both level of a fluid within a tank such as the fuel tank of an aircraft, ship or vehicle, and its composition. Extension of the technique to the full evanescent wave cavity ring-down spectroscopy measurement of complex refractive index can enable the complex refractive index of the medium to be measured, for example 10 ppm accuracy or better. Further extension of the tapered regions into a fibre optic network allows the 3D shape of the fluid within a tank to be determined. Software analysis of the network response enables die dynamic level of the fluid and its condition to be monitored in real time with a small form, low cost configuration.

We next provide some further constructional details of an example sensor. This example instrument is constructed from a fibre optic taper designed to work at 635 nm, allowing light from a laser to propagate down and back past the sample region using a simple double-pass arrangement. The optical path length for the radiation is controlled by the diameter of the taper so that a thicker taper can be pulled for media with high optical density.

The dipstick is encased in a stainless steel tube such as a hypodermic needle and placed directly into the sample. The losses of the fibre are monitored in real-time, digitised and returned to a PC, for example via a USB bus. For a two-pass device a simple photo diode may be used as a detector; for a cavity ring-down device a photomultiplier is employed to resolve the ring-down.

In some preferred embodiments apparatus is provided which measures a response at between two and four different colours, for example using diode (or other) lasers or LEDs of different wavelengths. Since, as previously mentioned scattering is wavelength dependent (as 1/λ⁴) whereas a change in temperature of the monitored fluid is not wavelength dependent in the same way, by measuring a response at, say, three colours a signal characterising a single fuel can be distinguished from temperature change effects. The skilled person will appreciate that there are many ways of making the distinction—for example, the apparatus can be calibrated using a range of fluids and at different temperatures to provide correction values based on a common (temperature change) response at the different colours. Alternatively one or more of die wavelengths can be selected so that it substantially avoids any absorption features in the fuel, in effect providing a signal which varies with temperature alone. This can then be used to correct for temperature variation, for example taking a ratio of this signal to one at another wavelength at which there is absorption by the measured fuels.

Referring to FIGS. 16a and 16b we next describe, as an example, the design of a metal-cased dipstick 900 containing module 901 incorporating a tapered fibre optic sensor surface 902. The outer casing is permeable in the sensor region 904, for example by means of a cage, allowing the sample to enter freely without capillarity and to drain rapidly. The fibre optical pigtailed cable 906 is strained relieved and preferably capable of withstanding significant strain. The entire design is preferably chemically resistant (e.g. hardened) and capable of withstanding a range of operating temperatures.

An example dipstick specification is shown in table 5 below:

TABLE 5

| Item | Specification | | Comments |
|---|---|---|---|
| Dipstick | 1 | m | Overall length from tip to |
| Length | | | connector |
| Operational | 830 | nm | One or many |
| wavelength | | | |
| Mirror | 0.995 | | Cavity, Double pass |
| Specification | | | |
| Taper Length | 20 | mm | |
| Taper | 20 | μm | |
| Diameter | | | |

FIG. 16b shows a fibre optic cavity for the dipstick of FIG. 16a. The fibre optic cavity preferably comprises a continuous piece of fibre 906 without splices tapered and mirrored on each end, M1, M2. The integrity of the fibre cavity, its losses in propagation and taper pulling losses can limit the sensitivity of the technology and should therefore be kept low. The connection efficiency can affect the reproducibility of the results and although a simple FC/PC connector 908 may be sufficient, lower loss connectors are preferable.

An example fibre optic specification is shown in table 6 below:

TABLE 6

| Item | Specification | Comments |
|---|---|---|
| Operational Wavelength, | 830 | Single or Multimode |
| λ nm | | option |
| Propagation | 7 | Preferably optimised for |
| Loss/dB/km | | each λ |
| Index Profile | Step | Suits tapering |
| Coating | Polyimide | |
| Outer coating | e.g. PTFE | |
| Overall Length, | 1 ± 0.01 | Directly affects the ring- |
| L/m M1-M2 | | down time |
| Mirror 1, M1 | Flat polished fibre | e.g. ATC coating |
| | (Spec) | |
| Mirror 2, M2 | Flat polished fibre | |
| | (Spec) | |
| Connector, C | FC/PC | Lock fit other spec? |
| Outer protection | Along length | In place for a dipstick |

An example taper specification is shown in table 7 below:

TABLE 7

| Item | Specification | Comments |
|---|---|---|
| Minimum Diameter, | 15 ± 1 | May vary between 10-50 |
| D/μm | | |
| Length, L/mm | 20 ± 1 | e.g. L for taper <1.5D |
| Profile | Symmetric | Taper region profiled on- |
| | | line during manufacture |
| Loss in pulling | Loss <<1% | e.g. Measured online |
| Overall length | 1 ± 0.01 | Controlled by the cavity |
| (M1-M2)/m | | length |

Referring to FIG. 17a the module 901 is preferably fabricated from ceramic material such as zirconia or macor. It may be dropped into and secured in the outer dipstick case. This confers flexibility on the design; the core taper module can then easily be incorporated into designs for other applications or markets. The module includes a female 910 at each end of the sensor spaced apart by post(s) 912; it is loaded into a jig and sent for minor coating, at M1 and M2 for a fibre optic cavity and at M1 only for a two-pass taper.

An example taper module specification is shown in table 9 below, where the reference signs refer to FIG. 17a:

TABLE 8

| Item | Specification | Comments |
|---|---|---|
| Module length ML/mm | e.g. 50 ± 1 | |
| Ferrule 1, FI | | |
| F1L/mm | e.g. 7 ± 1 | |
| F1 Material | Zirconia (grade) | Macor (RTM) |
| F1 - finish | Polished flat with | |
| | fibre end | |
| M1 | 0.995 | e.g. ATC coated |
| Ferrule 2, F2 | | |
| F2L/mm | 7 ± 1 | |
| F2D/mm | 3 ± 1 | |
| F2 finish | Strain relief | |
| Post 1, PI | Length ML-F1L-F2L | Or e.g. a tray |
| | (1 mm thick) | |
| Post 2, P2 | As P1 | |
| Seals, S1, S2 | e.g. Vitrolock (RTM) | |

FIG. 17b shows the module of FIG. 17a incorporated into a dipstick.

The mirrors are preferably specified to maximise the light content of the cavity but to have sufficient reflectivity to be greater than the propagation losses by 10 percent. The ring-down time in the fibre is controlled by the losses of the cavity: 1) propagation loss at target wavelength; and 2) mirror reflectivities. The reflectivity of the mirror also controls the light intensity within the cavity. The fibre propagation loss specification and the mirror reflectivity are preferably specified to be consistent. Preferably the taper module has M1 and M2 coated and then the fibre may optionally be processed by dip-coating smart surfaces as described above onto the taper for target molecule sensing. The dipstick can then be assembled for testing.

An example dipstick specification is shown in table 9 below, which refers to the reference signs in FIG. 17b:

TABLE 9

| Item | Specification | Comments |
|---|---|---|
| Dipstick Length, DL/cm | e.g. 30 ± 0.5 | |
| Dipstick Diameter DD, | e.g. 4 ± 1 | |
| mm | | |
| Tip Length D1/cm | e.g 1 ± 0.1 | |
| Cage 916 Length CL/cm | 5 ± 0.1 | Covering the tapered region |
| | | Cage may be D-section or |
| | | along the length |
| Cage gauge | Mesh to be | |
| | specified | |
| Tail Length, D2/cm | 24 ± 0.5 | |
| Protective | Preferable | |
| Coating/P 914 | | |
| Seals, S | Ceramic Metal - | |
| | Vitrilock (RTM) | |
| Outer Case | Stainless Steel | |

FIG. 18 shows an example embodiment of a fuel monitoring system according to an embodiment of an aspect of the invention.

A fibre optic dipstick 900, for example as described above, is coupled via a fibre optic to an interface module 950 comprising a laser diode 952 and photodiode 954 and interface electronics 956. As illustrated, interface module 950 makes data relating to the optical response (absorption, related to fuel refractive index) available via a USB bus.

A control computer 960 is coupled to interface module 960 and provides a fuel characterisation data output, for example to an engine management system or to an electronically controllable fuel cut-off value (as illustrated later in FIGS. 21a and 21b). The control computer may be any suitably programmed general purpose computer, or a dedicated computer such as a digital signal processor and/or integrated with an existing computer system, for example incorporated within an existing engine management computer. The control computer comprises a processor, working memory, interface circuitry for the sensor module and data output, and program memory. In the illustrated embodiment the program memory comprises processor control code (which may be provided on a removable carrier such as a disk or programmed memory) for interfacing with the sensor, (optionally) determining a refractive index of the sensed fuel (this may, for example, be implemented using a lookup table), and mapping the sensor signal (and/or fuel refractive index) to fuel characterising output data, as well as interface driver code and operating system code. The fuel characterising output data may simply comprise data identifying a fuel type (for example diesel or petrol) or fuel grade, or whether the fuel has been contaminated (and optionally the likely contaminant), or whether the fuel is fraudulent because it contains traces, for example, of a dye or other indicator.

We now describe some specific applications of the fuel condition monitoring, in particular, Combustion Efficiency Optimization and Fuel Pack Integrity, including Water Contamination, determination.

The complex mixture of molecule that comprises a fuel pack has a refractive index related to the mole fraction of each of the components and their pure refractive indices. The multi-component refractive index can be predicted from the Clausius-Mosetti equation to provide refractive index as a function of composition. Alternatively, the refractive index of the fuel packs can be measured directly as can be seen in FIG. 19. The commercially available fuel packs have refractive indices between 1.425 and 1.46 and can reflect the alkane and additive composition. A sensor of the type we describe here may be calibrated in this way, for example to provide data for the look up table of FIG. 18.

The in-line dipstick tapered fibre optic with a controlled profile, minimum diameter and length is sensitive to the fuel composition on a single dip, FIG. 20. The taper profile can be fabricated to optimize the response for each of the fuel packs to monitor specific composition or to distinguish between different fuels. The response of the instrument is within milliseconds.

We next describe techniques for combustion efficiency optimization using embodiments of the invention. The combustion efficiency of a fuel depends on the Research Octane Number (RON) of the fuel and the fuel-oxidant mixture. An in-line fuel sensor capable of providing a real-time fuel-condition parameter in feedback signal to an engine management system can be used to optimize the oxygen-fuel mixture. An engine management system with feedback loop using a sensing system of the type described above for combustion efficiency optimisation is shown in FIG. 21a. FIG. 21b shows a similar system for preventing an incorrect type or grade of fuel being delivered to an engine. Arrangements of this type are able to provide a number of specific advantages as set out below.
a) The prevention of diesel combustion in a petrol engine. A simple cut-off can be provided to the engine management system when the incorrect fuel is delivered to the engine.
b) The assessment of fuel integrity before adding it to die engine, to determine whether die fuel has been contaminated.
c) The prevention of fuel duty fraud by detection of dye markers in the fuel.
d) The fuel pack compositional variation can be optimized in real-time during the combustion process to perform one or more of:
   (i) Combustion efficiency and increased performance.
   (ii) Reduction of emissions for leaner fuel burning.
   (iii) Optimisation of power output and consumption in power-critical deployment.
   (iv) Optimisation of combustion efficiency in response to reduced oxygen composition and temperature; generally combustion environmental conditions.
   (v) Engine wear compensation.

We now describe fuel pack integrity measurement and water contamination determination. The fuel pack composition integrity can be monitored during storage, delivery and at point of use by monitoring the R1 of the complex mixture. A typical fuel pack has a refractive index of 1.44 which can be modelled as a octane:toluene mixture 50:50 by volume. Adding water to this mixture produces a refractive index variation from 0-10% water from 1.4405-1.43041 with a slope of 1.03×10⁻³ per % water by volume. FIG. 22 shows variation of fuel pack composition with water concentration.

Confidence in the refractive index measurement in the fourth decimal place enables concentration of 100 ppm-10% to be measured. Temperature compensation needs to be made at for the 4^{th} decimal place as typically water varies its refractive index with temperature of order 4×10⁻³° C.⁻¹. Temperature compensation either by measuring the temperature with a thermistor or by optical compensation will provide the required accuracy.

Applications for the integrity measurements include:

a) Monitoring water levels in fuel during storage
b) Monitoring of biofouling in fuel system
c) Monitoring the capacity of water dispersing agents in the fuel pack. The fuel-water mix will eventually separate when the capacity of the dispersants has been exceeded. This can be determined by adding water to the fuel pack, monitoring the RI as the separation occurs.
d) Fuel delivery fraud is often performed with water dilution of the fuel—on the spot measurements will ensure fuel pack integrity on delivery.

No doubt many effective variants will occur to the skilled person. It will be understood that the invention is not limited to the described embodiments but encompasses modifications apparent to those skilled in the art found within the spirit and scope of the appended claims.

Further aspects of the invention are defined in the following clauses:

1. A fuel monitoring system, the system comprising:
an evanescent wave fuel sensor for monitoring said fuel, the sensor comprising a light source, an opto-electric transducer for providing an electrical signal in response to light from said light source, and having a light path between said light source and said opto-electric transducer including an evanescent wave sensing region; and
a processor coupled to said fuel sensor, for converting said electrical signal from said opt-electric transducer into a signal characterising said monitored fuel; and
an output coupled to said processor, for outputting a signal responsive to said fuel characterising signal.
   2. A fuel monitoring system as defined in clause 1 wherein said evanescent wave sensor comprises an optical fibre with a mirror at one end and wherein said evanescent wave sensing region of said sensor comprises a tapered region of said fibre.
   3. A fuel monitoring system as defined in clause 1 or 2 wherein said electrical signal is responsive to a coupling of said light from said light source into said fuel which is dependent upon a refractive index of said fuel and wherein said processor comprises means to determine said fuel characterising signal responsive to said fuel refractive index-dependent electrical signal.
   4. A fuel monitoring system as defined in any one of clauses 1 to 3 further comprising a temperature compensation system to compensate for variations in fuel temperature.
   5. A fuel monitoring system as defined in clause 4 wherein said sensor is configured to operate at two different wavelengths of said light and wherein said temperature compensation system comprises a system to compensate a response of said sensor to said fuel at a first of said wavelengths using the response of said sensor to said fuel at a second of said wavelengths.
   6. A system for detecting fuel excise duty fraud comprising the fuel monitoring system of any one of clauses 1 to 5.
   7. An engine management system comprising the fuel monitoring system of any one of clauses 1 to 5.
   8. Apparatus for determining a water level in fuel including the fuel monitoring system of any one of clauses 1 to 5.
   9. A system for protecting an engine from use of an inappropriate fuel, die system comprising a fuel monitoring system as defined in any one of clauses 1 to 5 and a fuel supply restriction system, to restrict a fuel supply to said engine responsive to said fuel characterising signal from said fuel monitoring system.
   10. A system as defined in clause 9 wherein said engine comprises a petrol engine and said inappropriate fuel comprises diesel fuel.
   11. A system as defined in clause 9 or 10 wherein said fuel supply restriction comprises an electrically operable cut-off valve.
   12. An engine management system for an engine comprising:
an evanescent wave optical fuel sensor for monitoring a condition of a fuel supply to said engine; and
a controller coupled to said fuel sensor and having an output to control operation of said engine responsive to said monitored condition of said fuel supply.
   13. A fluid storage tank having a three dimensional structure for containing fluid, and a three-dimensional array of fibre-optic sensors; and wherein said array of sensors is integrated into said tank structure.
   14. A fluid storage tank as defined in clause 13 wherein each said sensor comprises an evanescent wave fibre optic sensor.
   15. A fluid storage tank as defined in clause 13 or 14 further comprising a sensing system to determine a level of said fluid within said tank at a plurality of different orientations of said tank.
   16. A fluid storage tank as defined in clause 15 wherein said sensing system is configured to additionally determine a fluid condition parameter to determine a condition of said fluid in the vicinity of at least some of said sensors.
   17. A fluid level sensing system for determining a level of fluid in a container, the system comprising:
a sensor input to receive sensor data from at least two sets of fluid level sensors, a first set of sensors disposed at intervals along a first direction within said container and a second set of sensors disposed at intervals along a second direction within said container, said second direction being different to said first direction; and
a signal processing system to process said sensor data and able to determine a level of fluid in said container for a plurality of different orientations of said container.
   18. A fluid sensing system for determining a level of fluid in a container, the system comprising:
a sensor input to receive sensor data from a set of fluid sensors disposed at intervals along a first direction within said container; and
a signal processing system configured to process said sensor data to determine both a level of fluid in said container and a condition of said fluid at one or more of said sensors within said fluid.
   19. A fluid level sensing system a defined in clause 17 or 18 wherein said sensor input is configured to receive sensor data from at least two sets of said fluid sensors a first set of sensors disposed at intervals along a first direction within said container and a second set of sensors disposed at intervals along a second direction within said container, said second direction being different to said first direction; and wherein said signal processing system is configured to further determine a level of fluid in said container for a plurality of different orientations of said container.
   20. A fluid level sensing system as defined in clause 17, 18 or 19 wherein said sensor input is configured to obtain data from three sets of sensors disposed along substantially mutually orthogonal directions, and wherein said signal processing system is able to determine said fluid level substantially irrespective of an orientation of said container.
   21. A fluid level sensing system as defined in any one of clauses 17 to 20 wherein said sensors comprise evanescent wave sensors, and wherein said system further comprises an attenuated total internal reflection (ATIR) measuring system for driving said sensors to provide said sensor data.
   22. A fluid level sensing system as defined in clause 21 wherein said ATIR measuring system comprises a cavity ring-down spectroscopy system.
   23. A computer readable medium carrying software configured to implement the signal processing system of any one of clauses 17 to 22.
   24. A method of jointly determining depth of fluid in a tank and characterising the fluid according to depth, die method comprising:
providing a plurality of fibre optic sensors at a plurality of different depths within said fluid, each said fibre optic sensor comprising a region where an evanescent wave of light propagating within the fibre optic is able to interact with said fluid;
monitoring light propagating within the fibre optic associated with each said sensor region to determine a plurality of complex refractive index values of said fluid, one in the vicinity of each sensor region where said fluid is present; and
determining the depth of fluid in said tank and characterising said fluid according to depth using said plurality of complex refractive index values.
   25. A method as defined in clause 24 wherein said monitoring comprises monitoring at a plurality of different wavelengths to determine same plurality of complex refractive index values.
   26. A method as defined in clause 24 or 25 wherein said monitoring comprises monitoring over a rime interval, the method further determining one or more of an acceleration of said fluid, an acceleration of said tank, a rotation of said tank, a rate of rotation of said tank, and a rate of change of a volume of said fluid in said tank.
   27. A method as defined in clause 24, 25 or 26 wherein said characterising of said fluid comprises identifying a transition between a first component of said fluid and a second component of said fluid.
   28. A method as defined in clause 27 wherein said characterising of said fluid further comprises determining a depth of said transition within said tank.
   29. A method as defined in any one of clauses 24 to 28 wherein said tank is a fuel tank and wherein said fluid comprises fuel.
   30. A method as defined in any one of clauses 24 to 29 wherein said characterising comprises determining a level of a dye component of said fluid.
   31. Apparatus for jointly determining depth of fluid in a tank and characterising the fluid according to depth, the apparatus comprising:
a plurality of fibre optic sensors configured for positioning at a plurality of different depths within said fluid, each said fibre optic sensor comprising a region where an evanescent wave of light propagating within the fibre optic is able to interact with said fluid;
a monitor system to monitor light propagating within the fibre optic associated with each said sensor region to determine a plurality of complex refractive index values of said fluid, one in the vicinity of each sensor region where said fluid is present; and
a data processing system coupled to said monitoring system to determine the depth of fluid in said tank and to characterise said fluid according to depth using said plurality of complex refractive index values.
   32. Apparatus as defined in clause 31 wherein said monitoring system comprises means for monitoring at a plurality of different wavelengths to determine same plurality of complex refractive index values.
   33. Apparatus as defined in clause 31 or 32 wherein said data processing system is configured to determine, from time series data from said monitor system, one or more of an acceleration of said fluid, an acceleration of said tank, a rotation of said tank, a rate of rotation of said tank, and a rate of change of a volume of said fluid in said tank.
   34. Apparatus as defined in clause 31, 32 or 33 wherein said data processing system is configured to identify a transition between a first component of said fluid and a second component of said fluid.
   35. Apparatus as defined in clause 34 wherein said data processing system is configured to determine a depth of said transition within said tank.
   36. Apparatus as defined in any one of clauses 31 to 35 wherein said tank is a fuel tank and wherein said fluid comprises fuel.
   37. Apparatus as defined in any one of clauses 31 to 36 wherein said data processing system is configured to determine a level of a dye component of said fluid.
   38. A carrier medium carrying processor control code to implement the method of any one of clauses 24 to 30 or the data processing system of any one of clauses 31 to 37.

1-38. (canceled)

39. A fuel monitoring system, the system comprising:
an evanescent wave fuel sensor for monitoring said fuel, the sensor comprising a light source and a transducer for providing an electrical signal in response to light from said light source, and having a light path between said light source and said transducer including an evanescent wave sensing region; and
a processor coupled to said fuel sensor, for converting said, electrical signal from said transducer info a signal characterising said monitored fuel; and
an output coupled to said processor, for outputting a signal responsive to said fuel characterising signal.

40. A fuel monitoring system as claimed in claim 39 wherein said evanescent wave sensor comprises an optical fibre with a mirror at one end, and wherein said evanescent wave sensing region of said sensor comprises a tapered region of said fibre.

41. A fuel monitoring system as claimed in claim 39 wherein said electrical signal is responsive to a coupling of said light from said light source into said fuel which is dependent upon a refractive index of said fuel, and wherein said processor comprises means to determine said fuel characterising signal responsive to said fuel refractive index-dependent electrical signal.

42. A feel monitoring system as claimed in claim 39 further comprising a temperature compensation system to compensate for variations in temperature of said monitored fuel.

43. A fuel monitoring system as claimed in claim 42 wherein said sensor is configured to operate at two different light wavelengths, and wherein said temperature compensation system comprises a system to compensate a response of said sensor to said fuel at a first of said wavelengths using the response of said sensor to said fuel at a second of said wavelengths.

44. A system for detecting fuel excise duty fraud comprising the fuel monitoring system of claim 39.

45. An engine management system comprising the fuel monitoring system of claim 39.

46. Apparatus for determining a water level in fuel including the fuel monitoring system of claim 39.

47. A system for protecting an engine from use of an inappropriate fuel, the system comprising a fuel monitoring system as claimed in claim 39 and a fuel supply restriction system, to restrict a fuel supply to said engine responsive to said fuel characterising signal from said fuel monitoring system.

48. A system as claimed in claim 47 wherein said engine comprises a petrol engine and said inappropriate fuel comprises diesel fuel.

49. A system as claimed in claim 47 wherein said fuel supply restriction comprises an electrically operable cut-off valve.

50. An engine management system for an engine comprising:
an evanescent wave optical fuel sensor for monitoring a condition of a fuel supply to said engine; and
a controller coupled to said fuel sensor and having an output to control operation of said engine responsive to said monitored condition of said fuel supply.

51. A fluid storage tank having a three dimensional structure for containing fluid, and a three-dimensional array of fibre-optic sensors; and wherein said array of sensors is integrated into said tank structure.

52. A fluid storage tank as claimed in claim 51 wherein each said sensor comprises an evanescent wave fibre optic sensor.

53. A fluid storage tank as claimed in claim 51 further comprising a sensing system to determine a level of said fluid within said tank at a plurality of different orientations of said tank.

54. A fluid storage tank as claimed in claim 53 wherein said sensing system is configured to additionally determine a fluid condition parameter to determine a condition of said fluid in the vicinity of at least some of said sensors.

55. A fluid level sensing system for determining a level of fluid in a container, the system comprising:
a sensor input to receive sensor data from at least two sets of fluid level sensors, a first set of sensors disposed at intervals along a first direction within said container and a second set of sensors disposed at intervals along a second direction within said container, said second direction being different to said first direction; and
a signal processing system to process said sensor data and able to determine a level of fluid in said container for a plurality of different orientations of said container.

56. A fluid sensing system for determining a level of fluid in a container, the system comprising:
a sensor input to receive sensor data from a set of fluid sensors disposed at intervals along a first direction within said container; and
a signal processing system configured to process said sensor data to determine both a level of fluid in said container and a condition of said fluid at one or more of said sensors within said fluid.

57. A fluid level sensing system as claimed in claim 55 wherein said sensor input is configured to receive sensor data from at least two sets of said fluid sensors a first set of sensors disposed at intervals along a first direction within said container and a second set of sensors disposed, at intervals along a second direction within said container, said second direction being different to said first direction; and wherein said signal processing system is configured to further determine a level of fluid in said container for a plurality of different orientations of said container.

58. A fluid level sensing system as claimed in claim 55 wherein said sensor input is configured to obtain data from three sets of sensors disposed along substantially mutually orthogonal directions, and wherein said signal processing system is able to determine said fluid level substantially irrespective of art orientation of said container.

59. A fluid level sensing system as claimed in claim 55 wherein said sensors comprise evanescent wave sensors, and wherein said system further comprises an attenuated total internal reflection (ATIR) measuring system for driving said sensors to provide said sensor data.

60. A fluid level sensing system as claimed in claim 59 wherein said ATIR measuring system comprises a cavity ring-down spectroscopy system.

61. A computer readable medium carrying software configured to implement the signal processing system of claim 55.

62. A method of jointly determining depth of fluid in a tank and characterising the fluid according to depth, the method comprising:
providing a plurality of fibre optic sensors at a plurality of different depths within said fluid, each said fibre optic sensor comprising a region where an evanescent wave of light propagating within the fibre optic is able to interact with said fluid;
monitoring light propagating within the fibre optic associated with each said sensor region to determine a plurality of complex refractive index values of said fluid, one in the vicinity of each sensor region where said fluid is present; and
determining the depth of fluid in said tank and characterising said fluid according to depth using said plurality of complex refractive index, values.

63. A method as claimed in claim 62 wherein said monitoring comprises monitoring at a plurality of different wavelengths to determine same plurality of complex refractive index values.

64. A method as claimed in claim 62 wherein said monitoring comprises monitoring over a time interval, the method further determining one or more of an acceleration of said fluid, an acceleration of said tank, a rotation of said tank, a rate of rotation of said tank, and a rate of change of a volume of said fluid in said tank.

65. A method as claimed in claim 62 wherein said characterising of said fluid comprises identifying a transition between a first component of said fluid and a second component of said fluid.

66. A method as claimed in claim 65 wherein said characterising of said fluid further comprises determining a depth of said transition within said tank.

67. A method as claimed in claim 62 wherein said tank is a fuel tank and wherein said fluid comprises fuel.

68. A method as claimed in claim 62 wherein said characterising comprises determining a level, of a dye component of said fluid.

69. Apparatus for jointly determining depth of fluid in a tank and characterising the fluid according to depth, the apparatus comprising:
a plurality of fibre optic sensors configured for positioning at a plurality of different depths within said fluid, each said fibre optic sensor comprising a region where an evanescent wave of light propagating within the fibre optic is able to interact with said fluid;
a monitor system to monitor light propagating within the fibre optic associated with each said sensor region to determine a plurality of complex refractive index values of said fluid, one in the vicinity of each sensor region where said fluid is present; and
a data processing system coupled to said monitoring system to determine the depth of fluid in said tank and to characterise said fluid according to depth using said plurality of complex refractive index values.

70. Apparatus as claimed in claim 69 wherein said monitoring system comprises means for monitoring at a plurality of different wavelengths to determine same plurality of complex refractive index values.

71. Apparatus as claimed in claim 69 wherein said data processing system is configured to determine, from time series data from said monitor system, one or more of an acceleration of said fluid, an acceleration of said tank, a rotation of said tank, a rate of rotation of said tank, and a rate of change of a volume of said fluid in said tank.

72. Apparatus as claimed in claim 69 wherein said data processing system is configured to identify a transition between a first component of said fluid and a second component of said fluid.

73. Apparatus as claimed in claim 72 wherein said data processing system, is configured to determine a depth of said transition within said tank.

74. Apparatus as claimed in claim 69 wherein said tank is a fuel tank and wherein said fluid comprises fuel.

75. Apparatus as claimed in claim 69 wherein said data processing system is configured to determine a level of a dye component of said fluid.

76. A carrier medium carrying processor control code to implement the method of claim 62.

77. A carrier medium carrying processor control code to implement the data processing system of claim 69.
